(19) United States
(12) Patent Application Publication
(10) Pub. No.: US 2010/0045164 A1
(43) Pub. Date: Feb. 25, 2010

(54) GLASS FOR AN ILLUMINATING MEANS WITH EXTERNAL ELECTRODES

(76) Inventors: Joerg Fechner, Mainz (DE); Martin Letz, Klein-Winternheim (DE); Steffen Reichel, Mehlingen (DE); Franz Ott, Konnersreuth (DE); Brigitte Hueber, Schwandorf (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/794,505

(22) PCT Filed: Dec. 29, 2005
(86) PCT No.: PCT/EP2005/014120

§ 371 Date: Nov. 6, 2009

(30) Foreign Application Priority Data
Jan. 4, 2005 (DE) 10 2005 000 660.4
Jan. 4, 2005 (DE) 10 2005 000 663.9
Jan. 4, 2005 (DE) 10 2005 000 664.7
Mar. 19, 2005 (DE) 20 2005 004 459.8
Nov. 24, 2005 (DE) 10 2005 056 298.1

(51) Int. Cl. H01J 17/04; H01J 11/02; C03C 3/095; C03C 3/089; C03C 3/091; C03C 3/093

(52) U.S. Cl. 313/493; 313/234; 313/636; 501/64; 501/65; 501/66; 501/67

(57) ABSTRACT

The invention concerns a glass composition for a glass body of an illuminating means with external electrodes, wherein the quotient of the loss angle (tan δ[10⁻⁴]) and the dielectric constant (∈′) amounts to tan δ[10⁻⁴]/∈′<5, i.e., tan δ/∈′<5×10⁻⁴). In this way, the total power loss of the illuminating means with external electrodes can be minimized in a targeted manner by means of the glass properties.

The invention concerns a glass for a glass body of illuminating means with external electrodes, such as, for example, a fluorescent lamp, in particular an EEFL fluorescent lamp.

Glasses with UV-absorbing properties, which are known in and of themselves, are usually used for the production of liquid crystal displays (LCDs), monitors, and other image screens, as well as for the production of gas-discharge tubes, in particular of fluorescent lamps. Such glasses are used, among other things, as the light source for back-illuminated image screens (so-called backlight displays). Such fluorescent lamps for this application should have only very small dimensions and, correspondingly, the lamp glass has only an extremely small thickness.

The illuminating gas contained in such lamps is ignited, i.e., illuminated, by applying an electrical voltage by means of electrodes. Usually the electrodes are disposed inside the lamp, i.e., an electrically conducting metal wire is passed through the lamp glass in a gas-tight manner. However, it is also possible to ignite the illuminating gas or the plasma present inside the lamp by an externally applied electrical field, i.e., by external electrodes, which are not passed through the lamp glass.

Such lamps are usually called EEFL lamps (external electrode fluorescent lamps). It is important in this case that the irradiated high-frequency energy is not absorbed by the lamp glass or is absorbed only to a slight extent, in order to ignite the illuminating gas enclosed within the fluorescent lamp. Up until now, it has been assumed that the glass has an extremely small dielectric constant as well as an extremely small dielectric loss angle tan δ. Thus, the dielectric loss angle serves as a measurement for the energy that is absorbed by the glass in the excited dielectric alternating field and which is converted to heat loss. Therefore, very particular requirements are placed on the glass and its properties.

Accordingly, the object of the present invention is to provide another glass, which, in addition to other applications, will be suitable also for displays or screens, for example, for backlight displays, in particular, illuminating means with external electrodes, such as fluorescent lamps, which can be externally ignited by induction and do not require metal wires or electrodes that are passed through the enveloping lamp glass. In this way, a glass should be made available whose properties can be modified and optimized in such a way that as little as possible high-frequency energy that is irradiated is absorbed, i.e, the total power loss of a lamp glass of an illuminating means with external electrodes should be reduced to a minimum. In addition, the glass composition shall have good UV-absorbing properties.

According to the invention, the object is solved by a glass composition for a glass body of an illuminating means with external electrodes, wherein the quotient of the loss angle and the dielectric constant tan δ[10⁻⁴]/∈′ amounts to <5, preferably <4 and <3, most particularly preferred <2 and <1.5; a most particularly preferred embodiment possesses a tan δ[10⁻⁴]/∈′ of <1. In particular, the quotient can also be adjusted to <0.7 and <0.5.

The values for tan δ are given in values of 10⁻⁴. It results from this that the quotient tan δ[10⁻⁴]/∈′ is <5, or if tan δ is given as an absolute value, that the quotient tan δ/∈′ is <5×10⁻⁴.

Accordingly, as already explained, preferably tan δ/∈′ is <4×10⁻⁴, still more preferably tan δ/∈′ is <3×10⁻⁴, and more preferably again tan δ/∈′ is <2×10-4, in particular the quotient tan δ/∈′ is <1.5×10⁴. Most particularly preferred, tan δ/∈′ is <0.7×10⁻⁴, in particular tan δ/∈′ is <0.5×10⁻⁴.

As a numerical example, let us take the following:

tan δ=0.001 or tan δ[10⁻⁴]=10 and ∈′=4,

then the quotient tan δ[10⁻⁴]/∈′=10⁻⁴=2.5 or tan δ/∈′=0.001:4=2.5×10-4

The invention thus concerns a glass for a glass body of an illuminating means with external electrodes, in which, in order to obtain a power loss Pₗₒₛₛ that is as small as possible and thus an efficiency that is as high as possible, the quotient of the loss angle tan δ[10⁻⁴], i.e., tan δ [value indicated in 10⁻⁴] and the dielectric constant ∈′ should not reach a specific upper limit. The plasma is ignited externally here, whereby the glass functions as a capacitor. For a simple geometry with planar elektrodes on the end surfaces of a closed glass tube, the power loss (designated as Pₗₒₛₛ below) can be described approximately by:

$${P}_{loss} \approx 2 \cdot \frac{1}{ω \cdot {ɛ}_{0}} \cdot \frac{tan δ [ {10}^{- 4} ]}{{ɛ}^{′}} \cdot \frac{d}{A} \cdot {I}^{2}$$

wherein the following apply:

ω: angular frequency

tan δ[10⁻⁴]: loss angle; value in [10⁻⁴]

∈′: dielectric constant

d: thickness of the capacitor (here: thickness of the glass)

A: electrode surface and

I: current intensity

∈₀: electric constant=8.8542 10⁻¹² As/(Vm)

Accordingly, the glass properties are influenced in a targeted manner by adjusting the quotient tan δ/∈′ in a specific range, whereby the desired total power loss can be minimized. This can be achieved by employing the glasses according to the invention.

According to the invention, it was surprisingly found that the object named above can be solved in an extremely cost-favorable manner with the glass compositions according to the invention. It has been surprisingly shown that such a glass is very well suited to applications in fluorescent lamps. The invention thus particularly concerns glass compositions and their use.

For employing such an illuminating means with external electrodes, such as, for example, an EEFL fluorescent lamp, the quotient lies at <5 or <5·10⁻⁴, preferably <4.5 or <4.5×10⁻⁴, particularly preferred <4.0 or <4.0×10⁻⁴, in particular <3 or <3×10⁻⁴, still more preferred <2.5 or <2.5×10⁻⁴. Good properties are obtained also in the range of 0.75-2.5 or 0.75×10⁻⁴ to <2.5×10⁻⁴. Most particularly preferred is a quotient of <1.0 or <1.0×10⁻⁴, particularly <0.75 or <0.75×10⁻⁴.

In particular, such a quotient can be adjusted in a targeted manner in a glass composition, in particular, in silicate glasses, by incorporating highly polarizable elements in oxide form in the glass matrix. These are, e.g., the oxides of Ba, Hf, Ta, W, Re, Os, Ir, Pt, Pb, Bi, La, Ce, Pr, Nd, Sm, Eu, Gd, Tb, Dy, Ho, Er, Tm, Yb and Lu.

The glasses employed according to the invention and obtainable according to the invention preferably have a relatively high dielectric constant (DC). The dielectric constant at 1 MHz at 25° C. preferably amounts to >3 and >4, in particular lies in the range of 3.5 to 4.5, and more preferably amounts to >5 and >6, most particularly preferred >8. The dielectric loss factor tan δ[10⁻⁴] preferably amounts to a maximum of 120 and preferably to less than 100. Particularly preferred are loss factors of less than 80, wherein values of less than 50 and less than 30 are particularly suitable. Most particularly preferred are values of less than 15, in particular, a range between 1 and 15. The tan δ values can fluctuate, each time depending on the extent of impurities and on the production method. It is not a deciding factor, however, to adjust the individual values of loss angle tan δ and the dielectric constant ∈′ to be as small as possible independent of one another, but rather to set the two values in a relationship to one another. Actually, the quotient of the two parameters represents the critical value, by means of which the properties of the glass material are adjusted. The indicated values for the loss angle tan δ are given in units of 10⁻⁴ (tan δ[10⁻⁴]=numerical value or tan δ=numerical value×10⁻⁴).

The illuminating means with external electrodes is preferably a discharge lamp, such as a gas-discharge lamp, in particular, a low-pressure discharge lamp. In the case of low-pressure lamps, for example, in backlight lamps, the discrete UV lines are partially converted to the visible spectrum by means of the fluorescent layers. Therefore, the illuminating means can also be a fluorescent lamp, in particular an EEFL lamp, and most particularly preferred, a miniaturized fluorescent lamp.

As the illuminating means utilized according to the invention, for example, in the form of a so-called backlight, any illuminating means that is known to the person skilled in the art for this purpose can be employed, such as, for example, a discharge lamp such as a low-pressure discharge lamp, in particular a fluorescent lamp, most particularly preferred, a miniaturized fluorescent lamp.

The glass of the glass body of the illuminating means contains a glass composition according to the invention or consists of it. One or more individual, in particular, miniaturized illuminating means are preferably used, the glass body of which essentially contains the glasses according to the invention or consists of these.

For an illuminating means with external electrodes, such as an EEFL discharge lamp, the glass thus preferably has the following composition:

| | | |
|---|---|---|
| SiO₂ | 55-85 | wt. % |
| B₂O₃ | >0-35 | wt. % |
| Al₂O₃ | 0-25 | wt. %, |
| preferably | 0-20 | wt. %, |
| Li₂O | <1.0 | wt. % |
| Na₂O | <3.0 | wt. % |
| K₂O | <5.0 | wt. %, wherein |
| the Σ Li₂O + Na₂O + K₂O amounts to | <5.0 | wt. %, and |
| MgO | 0-8 | wt. % |
| CaO | 0-20 | wt. % |
| SrO | 0-20 | wt. % |
| BaO | 0-80 | wt. %, particularly |
| BaO | 0-60 | wt. %, |
| TiO₂ | 0-10 | wt. %, |
| preferably amounts to | >0.5-10 | wt. %, |
| ZrO₂ | 0-3 | wt. % |
| CeO₂ | 0-10 | wt. % |
| Fe₂O₃ | 0-3 | wt. %, |
| preferably | 0-1 | wt. %, |
| WO₃ | 0-3 | wt. % |
| Bi₂O₃ | 0-80 | wt. % |
| MoO₃ | 0-3 | wt. %, |
| SnO₂ | 0-2 | wt. %, |
| ZnO | 0-15 | wt. %, |
| preferably | 0-5 | wt. %, |
| PbO | 0-70 | wt. %, wherein |

the Σ Al₂O₃ + B₂O₃ + BaO + PbO + Bi₂O₃ amounts to 10-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

In addition, a particularly preferred embodiment of the glass composition according to the invention is:

| | | |
|---|---|---|
| SiO₂ | 55-85 | wt. % |
| B₂O₃ | >0-35 | wt. % |
| Al₂O₃ | 0-20 | wt. % |
| Li₂O | <0.5 | wt. % |
| Na₂O | <0.5 | wt. % |
| K₂O | <0.5 | wt. %, wherein |
| the Σ Li₂O + Na₂O + K₂O amounts to | <1.0 | wt. %, and |
| MgO | 0-8 | wt. % |
| CaO | 0-20 | wt. % |
| SrO | 0-20 | wt. % |
| BaO | 15-60 | wt. %, particularly |
| BaO | 20-35 | wt. %, wherein |
| the Σ MgO + CaO + SrO + BaO amounts | 15-70 | wt. %, |
| to | | |
| particularly | 20-40 | wt. %, and |
| TiO₂ amounts to | 0-10 | wt. %, |
| preferably | >0.5-10 | wt. %, |
| ZrO₂ | 0-3 | wt. % |
| CeO₂ | 0-10 | wt. %, |
| preferably | 0-1 | wt. %, |
| Fe₂O₃ | 0-1 | wt. % |
| WO₃ | 0-3 | wt. % |
| Bi₂O₃ | 0-80 | wt. % |
| MoO₃ | 0-3 | wt. %, |
| SnO₂ | 0-2 | wt. %, |
| ZnO | 0-10 | wt. %, |
| preferably | 0-5 | wt. %, |
| PbO | 0-70 | wt. %, wherein |

the Σ Al₂O₃ + B₂O₃ + BaO + PbO + Bi₂O₃ amounts to 10-80 wt. %, as well as refining agents in the usual concentrations.

Particularly preferred is glass free of alkalis, except for unavoidable impurites.

Accordingly, borosilicate glasses are particularly preferred as glasses for use in the illuminating means employed according to the invention. Borosilicate glasses comprise as primary components SiO₂ and B₂O₃ and as additional components an alkaline-earth oxide such as e.g., CaO, MgO, SrO and BaO and optionally an alkali oxide such as, e.g., Li₂O, Na₂O und K₂O.

Borosilicate glasses with a content of B₂O₃ between 5 and 15 wt. % show a high chemical stability. In addition, such borosilicate glasses can also be adjusted relative to their coefficient of thermal expansion (so-called CTE) by the selection of the composition range of metals, for example, tungsten or metal alloys such as KOVAR.

Borosilicate glasses with a content of B₂O₃ between 15 and 25 wt. % show a good processability as well as also a good adaptation of the thermal expansion coefficient (CTE) to the metall tungsten and the alloy KOVAR (Fe—Co—Ni alloy).

Borosilicate glasses with a content of B₂O₃ between 25 and 35 wt. % show a particularly small dielectric loss factor tan δ when used as a lamp glass, whereby these glasses are particularly advantageous for use according to the invention in lamps which have electrodes disposed outside the lamp bulb, such as electrode-less gas-discharge lamps.

According to one embodiment of the invention, the basic glass usually preferably contains at least 30 wt. % or at least 40 wt. % SiO₂, whereby at least 50 wt. % and preferably at least 55 wt. % are particularly preferred. A most particularly preferred minimum quantity of SiO₂ amounts to 57 wt. %. The maximum quantity of SiO₂ amounts to 85 wt. %, in particular 75 wt. %, whereby 73 wt. % and, in particular, a maximum of 70 wt. % SiO₂ are most particularly preferred. In addition, ranges of 50-70 wt. % and of 55-65 wt. % are most particularly preferred. Glasses with a very high SiO₂ content are characterized by a small dielectric loss factor tan δ[value in 10⁻⁴] and are thus particularly suitable for the illuminating means with external electrodes according to the invention, such as electrode-less fluorescent lamps, taking into consideration the quotient tan δ/∈′.

B₂O₃ is contained in an amount of more than 0 wt. %, preferably more than 0.2 wt. %, preferably more than 2 wt % or 4 wt. % or 5 wt. % and, in particular, at least 10 wt. % or at least 15 wt. %, wherein at least 16 wt. % is particularly preferred. The highest quantity of B₂O₃ amounts to a maximum of 35 wt. %, but preferably a maximum of 32 wt. %, whereby a maximum of 30 wt. % is particularly preferred.

Although the glass of the invention in individual cases can also be free of Al₂O₃, it usually contains Al₂O₃ in a minimum quantity of 0.1, in particular 0.2 wt. %. Preferred is a minimum content of 0.3, whereby minimum quantities of 0.7, in particular at least 1.0 wt. % are particularly preferred. The highest quantity of Al₂O₃ amounts to 25 wt. %, whereby a maximum of 20 wt. %, in particular 15 wt. % is preferred. Ranges of 14 to 17 wt. % are most particularly preferred. In several cases, a maximum quantity of 8 wt. %, in particular 5 wt. %, has proven sufficient.

The sum of the alkali oxides preferably amounts to <5 wt. %, preferably <1 wt. %. Most particularly preferred, the glass composition is free of alkali, except for unavoidable impurities. Li₂O is preferred in an amount of 0-5, in particular <1.0 wt. %, Na₂O is preferred in an amount of 0-3, in particular <3.0 wt. %, and K₂O is preferably used in an amount of 0-9, in particular <5.0 wt. %, whereby a minimum quantity of ≦0.1 wt. % or ≦0.2 and in particular ≦0.5 wt. % is preferred each time.

The alkaline-earth oxides Mg, Ca and Sr according to the invention are contained in each case in an amount of 0-20 wt. %, and in particular, in an amount of 0-8 wt. % or 0-5 wt. %. The content of individual alkaline-earth oxides amounts to a maximum of 20 wt. % for CaO; in individual cases, however, maximum contents of 18, in particular a maximum of 15 wt. %, are sufficient. In several cases, a maximum content of 12 wt. % has been demonstrated to be sufficient. Although the glass according to the invention can also be free of calcium components, the glass according to the invention usually, however, contains at least 1 wt. % CaO, whereby contents of at least 2 wt. %, in particular at least 3 wt. %, are preferred. In practice, a minimum content of 4 wt. % has been demonstrated to be appropriate. The lower limit for MgO in individual cases amounts to 0 wt. %, whereby, however, at least 1 wt. % and preferably at least 2 wt. % are preferred. The maximum content of MgO in the glass according to the invention amounts to 8 wt. %, whereby a maximum of 7 and in particular a maximum of 6 wt. % are preferred. SrO can be completely omitted in the glass according to the invention; however, it is preferably contained in an amount of 1 wt. %, in particular at least 2 wt. %.

In order to adjust the quotient of tan δ and ∈′ to be as small as possible according to the invention, the glass composition contains highly polarizable elements in oxide form, incorporated in the glass matrix. Such highly polarized elements in oxide form can be selected from the group consisting of the oxides of Ba, Cs, Hf, Ta, W, Re, Os, Ir, Pt, Pb, Bi, La, Ce, Pr, Nd, Sm, Eu, Gd, Tb, Dy, Ho, Er, Tm, Yb and/or Lu.

Preferably, at least one of these oxides is contained in the glass composition. Mixtures of two or more of these oxides may also be present. At least one of these oxides is thus preferably contained in a quantity of >0 to 80 wt. %, preferably from 5 to 75, particularly preferred 10 to 70 wt. %, in particular 15 to 65 wt. %. In addition, 15 to 60 wt. %, 20 to 55 or 20 to 50 wt. % are preferred. Even more preferred are 20 to 45 wt. %, in particular, 20 to 40 wt. % or 20 to 35 wt. %. Particularly preferred, the lower limit should not go below 15, in particular 18, preferably 20 wt. %.

Particularly preferred, Cs₂O, BaO, PbO, Bi₂O₃ as well as the rare-earth metal oxides lanthanum oxide, gadolinium oxide, ytterbium oxide, are present in the glass composition according to the invention.

Particularly preferred, at least 15 wt. %, still more preferred 18 wt. %, in particular 20 wt. %, and most particularly preferred, more than 25 wt. % of one or more of the highly polarizable elements are contained in oxide form in the glass composition.

The content of CeO₂ preferably amounts to 0-5 wt. %, whereby quantities of 0-1 and in particular 0-0.5 wt. % are preferred. The content of Nd₂O₃ preferably amounts to 0-5 wt. %, whereby quantities of 0-2, in particular 0-1 wt. % are particularly preferred. Bi₂O₃ is preferably present in a quantity of 0 to 80 wt. %, preferably of 5 to 75, particularly preferred 10 to 70 wt. %, in particular 15 to 65 wt. %. In addition, 15 to 60 wt. %, 20 to 55 or 20 to 50 wt. % are preferred. Even more preferred are 20 to 45 wt. %, in particular 20 to 40 wt. % or 20 to 35 wt. %.

By the addition of at least one of these polarizable oxides in the surprisingly high contents indicated above, the glass properties can thus be influenced in a targeted manner, so that the total power loss is clearly reduced in comparison to glasses usually employed in lighting devices with external electrodes and can be decreased to a minimum.

The sum of all alkaline-earth oxides according to the invention thus preferably amounts to 0-80 wt. %, particularly 5-75, preferably 10-70 wt. %, particularly preferred 20-60 wt. %, most particularly preferred 20-55 wt. %. Additionally preferred are 20-40 wt. %.

The glass can be free of ZnO, but preferably contains a minimum quantity of 0.1 wt. % and a maximum content of at most 15 wt. %, whereby maximum contents of 6 wt. % or 3 wt. % can still be fully appropriate. ZrO₂ is contained in an amount of 0-5 wt. %, in particular 0-3 wt. %. whereby a maximum content of 3 wt. % has been demonstrated to be sufficient in many cases. In addition, WO₃ and MoO₃, independently of one another, can each be contained in a quantity of 0-5 wt. % or 0-3 wt. %, but in particular from 0.1 to 3 wt. %.

It has been demonstrated as particularly preferred according to the invention if the sum of Al₂O₃+B₂O₃+Cs₂O+BaO+Bi₂O₃+PbO lies in the range of 15 to 80 wt. %, preferably 15 to 75 wt. %, in particular 20 to 70 wt. %. Since B₂O₃ is usually used with a maximum quantity of 35 wt. %, the remaining 45 wt. % is distributed among one or more of the polarizable oxides BaO, Bi₂O₃ Cs₂O and PbO.

According to a preferred embodiment, the PbO content is advantageously adjusted to 0 to 70 wt. %, preferably 10-65 wt. %, more preferably 15-60 wt. %. Particularly preferred, 20 to 58 wt. %, 25 to 55 wt. %, in particular 35 to 50 wt. % are contained.

According to a special embodiment, if the PbO content is more than 50 wt. %, in particular, if it is more than 60 wt. %, alkalis can be added to the glass in a content of more than 3 wt. %, in particular more than 4 wt. % or more than 5 wt. %, whereby no more than 10 wt. % should be contained, so that, nevertheless, the requirement for the quotient tan δ[10⁻⁴]/∈′<5 or tan δ/∈′<5×10⁻⁴ will still be fulfilled. If the glasses according to the invention do not contain PbO, then they are preferably free of alkali according to the invention.

The glasses may also contain TiO₂ for adjusting the “UV edge” (absorption of UV radiation), although they may also in principle be free thereof. The highest content of TiO₂ preferably amounts to 10 wt. %, in particular at most 8 wt. %, whereby at most 5 wt. % is preferred. A preferred minimum content of TiO₂ amounts to 1 wt. %. Preferably, at least 80% to 99%, in particular 99.9 or 99.99% of the TiO₂ contained is present as Ti⁴⁺. In several cases, Ti⁴⁺ contents of 99.999% have been demonstrated as meaningful, whereby the melt is preferably produced under oxidative conditions. Oxidative conditions are thus particularly to be understood as those in which titanium is present as Ti⁴⁺ or is oxidized to this stage, in the above-indicated quantity. These oxidative conditions can easily be achieved in the melt, for example, by addition of nitrates, particularly alkali nitrates and/or alkaline-earth nitrates. An oxidative melt can also be obtained by blowing in oxygen and/or dry air. It is also possible to produce an oxidative melt by means of an oxidizing burner adjustment, e.g., when the batch is melted down.

If the TiO₂ contents of the glass composition are >2 wt. % and a batch with a total Fe₂O₃ content of >5 ppm is used, it is preferably refined with As₂O₃ and melted with nitrate. The nitrate is preferably added as an alkali nitrate with contents of >1 wt. % in order to suppress a coloring of the glass in the visible region (the formation of ilmenite (FeTiO₃) mixed oxide). In addition, refining with Sb₂O₃ and nitrate is also possible.

Although nitrate is added to the glass during the melting down, preferably in the form of alkali and/or alkaline-earth nitrates, the nitrate concentration in the finished glass after refining only amounts to a maximum of 0.01 wt. % and in many cases at most 0.001 wt. %.

The content of Fe₂O₃ preferably amounts to 0-5 wt. %, whereby quantities of 0-1 and, in particular, 0-0.5 wt. % are preferred. The content of MnO₂ amounts to 0-5 wt. %, whereby quantities of 0-2, in particular, 0-1 wt. % are preferred. The component MoO₃ is contained in an amount of 0-5 wt. %, preferably 0-4 wt. % and As₂O₃ and/or Sb₂O₃ are each contained in an amount of 0-1 wt. % in the glass according to the invention, whereby the minimum contents of the two together preferably amounts to 0.1, in particular 0.2 wt. %. The glass according to the invention, in a preferred embodiment, contains, if needed, small quantities of SO₄²⁻ of 0-2 wt. %, as well as Cl⁻ and/or F⁻ also in an amount of 0-2 wt. % for each.

Fe₂O₃ can be added to the glass in an amount of up to 1 wt. %. Preferably, however, the contents lie clearly below this amount. If iron is contained, it is converted into its oxidation state of 3⁺ by the oxidizing conditions during the melting, for example, by use of nitrate-containing raw materials, whereupon discolorations in the visible wavelength region are minimized. Fe₂O₃ is preferably contained in the glass in contents of <500 ppm. Fe₂O₃ is generally present as an impurity.

In particular, a discoloration of the glasses, particularly upon addition of TiO₂ in contents of >1 wt. %, in the visible wavelength region can be at least partially avoided by keeping the glass melt essentially free of chloride and, in particular, no chloride and/or Sb₂O₃ is added for refining during the glass melting. It was found that a blue coloring of the glass, as occurs in particular with the use of TiO₂, can be avoided, if chloride is not employed as a refining agent. The maximum content of chloride as well as fluoride according to the invention amounts to 2, in particular 1 wt. %, whereby contents of a max. 0.1 wt. % are preferred.

In addition, it has been shown that sulfates such as, e.g., those that are utilized as refining agents, just like the above-named agents, also lead to a discoloration of the glass in the visible wavelength region. Therefore, sulfates are preferably also omitted. The maximum content of sulfate according to the invention amounts to 2 wt. %, in particular, 1 wt. %, whereby contents of a max. 0.1 wt. % are preferred. The wavelength region between 380 nm and 780 nm is understood as the visible wavelength region in the present application.

In addition, it was found for the glasses that the previously described disadvantages can be avoided still further, if refining is conducted with As₂O₃, particularly under oxidizing conditions. Preferably, the glass contains 0.01-1 wt. % As₂O₃.

It has been shown that although the glasses are very stable relative to a solarization with UV irradiation, the solarization stability can be further increased by small contents of PdO, PtO₃, PtO₂, PtO, RhO₂, Rh₂O₃, IrO₂ and/or Ir₂O₃. The usual maximum content of such substances amounts to a maximum of 0.1 wt. %, preferably a maximum of 0.01 wt. %, whereby a maximum of 0.001 wt. % is particularly preferred. The minimum content for these purposes usually amounts to 0.01 ppm, whereby at least 0.05 ppm and, in particular at least 0.1 ppm is preferred.

The above-named glass compositions are particularly designed for illuminating means with external electrodes, in which there is no sealing of the glass with electrode leads, i.e., EEFL lighting devices without electrode leads. Since the coupling is made by means of electric fields in the case of an electrode-less EEFL backlight, the glass compositions described below are also particularly suitable, which are characterized by an appropriate quotient of the loss factor and the dielectric constant in the range according to the invention:

| | | |
|---|---|---|
| SiO₂ | 35-65 | wt. % |
| B₂O₃ | 0-15 | wt. % |
| Al₂O₃ | 0-20 | wt. %, |
| preferably | 5-15 | wt. %, |
| Li₂O | 0-0.5 | wt. % |
| Na₂O | 0-0.5 | wt. % |
| K₂O | 0-0.5 | wt. %, wherein |
| the Σ Li₂O + Na₂O + K₂O amounts to | 0-1 | wt. %, and |
| MgO | 0-6 | wt. % |
| CaO | 0-15 | wt. % |
| SrO | 0-8 | wt. % |
| BaO | 1-20 | wt. %, particularly |
| BaO | 1-10 | wt. %, |
| TiO₂ | 0-10 | wt. %, |
| preferably amounts to | >0.5-10 | wt. %, |
| ZrO₂ | 0-1 | wt. % |
| CeO₂ | 0-0.5 | wt. % |
| Fe₂O₃ | 0-0.5 | wt. %, |
| WO₃ | 0-2 | wt. % |
| Bi₂O₃ | 0-20 | wt. % |
| MoO₃ | 0-5 | wt. %, |
| SnO₂ | 0-2 | wt. %, |
| ZnO | 0-5 | wt. %, |
| preferably | 0-3 | wt. %, |
| PbO | 0-70 | wt. %, wherein |

the Σ Al₂O₃ + B₂O₃ + BaO + PbO + Bi₂O₃ amounts to 8-65 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

Further, the following glass compositions are also preferred:

| | | |
|---|---|---|
| SiO₂ | 50-65 | wt. % |
| B₂O₃ | 0-15 | wt. % |
| A1₂O₃ | 1-17 | wt. %, |
| Li₂O | 0-0.5 | wt. % |
| Na₂O | 0-0.5 | wt. % |
| K₂O | 0-0.5 | wt. %, wherein |
| the Σ Li₂O + Na₂O + K₂O amounts to | 0-1 | wt. %, and |
| MgO | 0-5 | wt. % |
| CaO | 0-15 | wt. % |
| SrO | 0-5 | wt. % |
| BaO | 20-60 | wt. %, particularly |
| BaO | 20-40 | wt. %, |
| TiO₂ | 0-1 | wt. %, |
| ZrO₂ | 0-1 | wt. % |
| CeO₂ | 0-0.5 | wt. % |
| Fe₂O₃ | 0-1 | wt. %, |
| preferably | 0-0.5 | wt. %, |
| WO₃ | 0-2 | wt. % |
| Bi₂O₃ | 0-40 | wt. % |
| MoO₃ | 0-5 | wt. %, |
| SnO₂ | 0-2 | wt. % |
| ZnO | 0-3 | wt. %, |
| PbO | 0-30 | wt. %, particularly |
| PbO | 10-20 | wt. %, wherein |

the Σ Al₂O₃ + B₂O₃ + BaO + PbO + Bi₂O₃ amounts to 10-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

All of the above-named glass compositions preferably contain the quantities of Fe₂O₃ indicated above and are most preferably essentially free of Fe₂O₃.

According to another preferred embodiment, the glass composition according to the invention is made of SiO₂ with and without dopings. Within the scope of the invention, dopings mean doping oxides, in particular, the oxides, which were named individually with the respective quantities.

A preferred composition range of the glass compositions, of this embodiment according to the invention is:

| | |
|---|---|
| SiO₂ | 90-100 wt. % |
| TiO₂ | 0-10 wt. % |
| CeO₂ | 0-5 wt. %. |

In this way, the upper limit of the SiO₂ content is calculated as the quantity that results in 100 wt. %—all the lower limits of the doping oxides present, i.e., the sum of all these lower limits is subtracted; if, for example, the content of TiO₂ amounts to 5-10 wt. % and the content of CeO₂ amounts to 2-5 wt. %, the upper limit for SiO₂ is calculated by: 100−(5+2)=93 wt. %. Most particularly preferred, pure SiO₂ is present without doping.

The maximum content of TiO₂, in particular for UV blocking of the glass, amounts to 10 wt. %, whereby at most it preferably amounts to 8 wt. %, in particular at most 5 wt. %, whereby contents between 1 and 4 wt. % are also possible. The CeO₂ content at most amounts to 5 wt. %, whereby quantities of 0 to 4 wt. %, in particular, 0 to 3 wt. %, and even more preferable, of less than 1 wt. % may also be adjusted. Additional oxides, which have already been described, may also be contained.

Methods for the production of SiO₂ glasses, in particular, of amorphous SiO₂ (silica glass, quartz glass) are, for example: gas-phase deposition, leaching of borosilicate glass and subsequent sintering, as well as production of a glass melt.

With the exception of the above-mentioned SiO₂ glasses, the glasses of the invention are particularly suitable for the production of flat glass, particularly according to the float method. In addition, glasses according to the invention are suitable for the production of tube glass, wherein the Danner method is particularly preferred. However, tube glass can also be produced according to the Velo or A drawing method. Most particularly suitable are glasses for the production of tubes with a diameter of at least 0.5 mm, in particular at least 1 mm and an upper limit of at most 2 cm, in particular, at most 1 cm. Particularly preferred tube diameters amount to between 2 mm and 5 mm. It has been shown that such tubes have a wall thickness of at least 0.05 mm, in particular at least 0.1 mm, whereby at least 0.2 mm is particularly preferred. Maximum wall thickness amounts to 1 mm at most, whereby wall thicknesses of <0.8 mm or <0.7 mm at most are preferred.

The glass of the illuminating means contains or consists of a glass composition, which additionally has a UV blocking action to the extent desired.

It has been shown that the glasses according to the invention, in particular borosilicate glasses or pure or doped SiO₂ glasses, are particularly well suitable for the production of lamp glasses for illuminating means with external electrodes, in particular gas-discharge tubes, as well as fluorescent lamps for EEFL fluorescent lamps (external electrode fluorescent lamps), in particular miniaturized fluorescent lamps, in particular for the background illumination of electronic display devices, such as displays and LCD image screens, as well as back-lighting displays (passive displays, so-called displays with a backlight unit) as a light source, such as, for example, for computer monitors, in particular TFT devices, as well as in scanners, advertising signs, medical instruments and devices for air and space travel, as well as for navigation technology, in cell phones and in PDAs (personal digital assistants). Such fluorescent lamps for this application have very small dimensions and, correspondingly, the lamp glass has only an extremely small thickness. Preferred displays as well as image screens are so-called flat-screen displays, used in laptops, in particular flat-screen backlight arrangements.

The glasses according to the invention, which are indicated for illuminating means with external electrodes, are for example, for use in fluorescent lamps with external electrodes, whereby these external electrodes can be formed, for example, by an electrically conductive paste.

Additionally preferred is the use of the glasses described here in the form of flat glass for flat gas-discharge lamps.

In a special embodiment, the glass is used for the production of low-pressure discharge lamps, in particular of backlight arrangements.

According to a first variant according to the invention, at least two illuminating means are preferably disposed parallel to one another and are preferably found between the base or support plate and the cover or substrate plate or disk. Appropriately, one or more recesses is provided in the support plate, and the one or more illuminating means are accommodated in these recesses. Preferably, one recess contains one illuminating means each time. The emitted light of the one or more illuminating means is reflected onto the display or screen.

Advantageously, a reflection layer is introduced onto the reflecting support plate according to this variant, i.e., in particular in the one or more recesses, and this layer uniformly scatters the light emitted from the illuminating means in the direction of the support plate as a type of reflector and thus provides for a homogeneous illumination of the display or image screen.

As a substrate or cover plate or disk, any usual plate or disk can be used for this purpose, which functions as the light diffusor unit or only as a cover, depending on the structure of the system and the purpose of application. The substrate or cover plate or disk accordingly can be, for example, an opaque diffusor disk or a clear transparent disk.

This arrangement according to the first variant of the invention is preferably used for larger displays, such as, for example, in television sets.

According to a second variant of the invention, the illuminating means corresponding to the system of the invention can also be arranged, for example, outside the light diffusor unit. Thus, the one or more illuminating means can be mounted externally, for example, onto a display or screen, whereby, by means of a light-transporting plate, a so-called LGP (light guide plate) serving as the light guide, the light is appropriately distributed uniformly over the display or the screen. Such light guide plates have a rough surface, for example, over which light is distributed.

According to a third variant of the system according to the invention, an electrode-less lamp system, i.e., a so-called EEFL system (external electrode fluorescent lamp) can also be used. For EEFL lamps, reference is made to: Cho G. et al., J. Phys. D: Appl. Phys. Vol. 37 (2004), pp. 2863-2867 and Cho T. S. et al. Jpn. J. Appl. Phys. Vol. 41, (2002), pp. 7518-7521, the disclosure content of which is incorporated to the full extent in the present disclosure.

In a preferred configuration of this third variant according to the invention, the light-generating unit, for example, has a surrounding space, which is bounded on top by a preferably structured disk, and on the bottom, by a support disk, as well as on the side by walls. For example, the illuminating means, such as fluorescent lamps, are found on the sides of the unit. This surrounding space, for example, can be divided further into individual radiation spaces, which can contain a discharge luminophore, which is applied, for example, in a predetermined thickness onto a support disk. Again, depending on the system structure, an opaque diffusor disk or a clear transparent disk, or the like, can be used as a cover plate or disk.

A backlight arrangement of the invention according to this variant, for example, is an electrode-less gas-discharge lamp, i.e., there are no leads, but only outer or external electrodes.

Particularly suitable according to the invention is glass for fluorescent lamps, which contains Ar, Ne, and possibly Xe and Hg. In a particular embodiment, the fluorescent lamps, however, are free of Hg and contain Xe as the filling gas. This embodiment of an illuminating means, which is based on the discharge of xenon atoms (xenon lamps) has proven to be particularly environmentally friendly as an illuminating means that is free of halogen and mercury.

The invention will be described below in more detail on the basis of the drawings. Here:

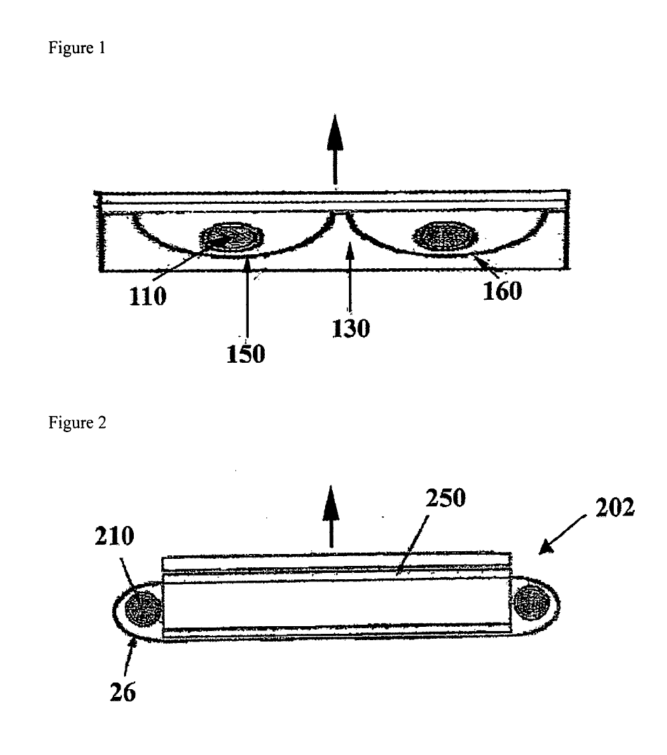

FIG. 1 shows a basic form of a reflecting base or support and substrate plate for a miniaturized backlight arrangement;

FIG. 2 shows a backlight arrangement with external electrodes;

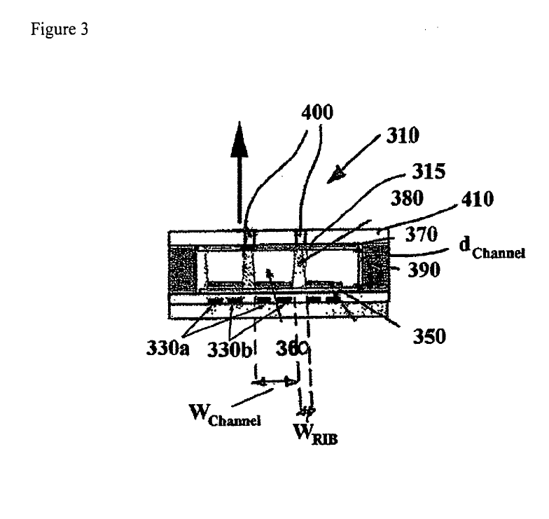

FIG. 3 shows a display arrangement with fluorescent lights mounted on the side;

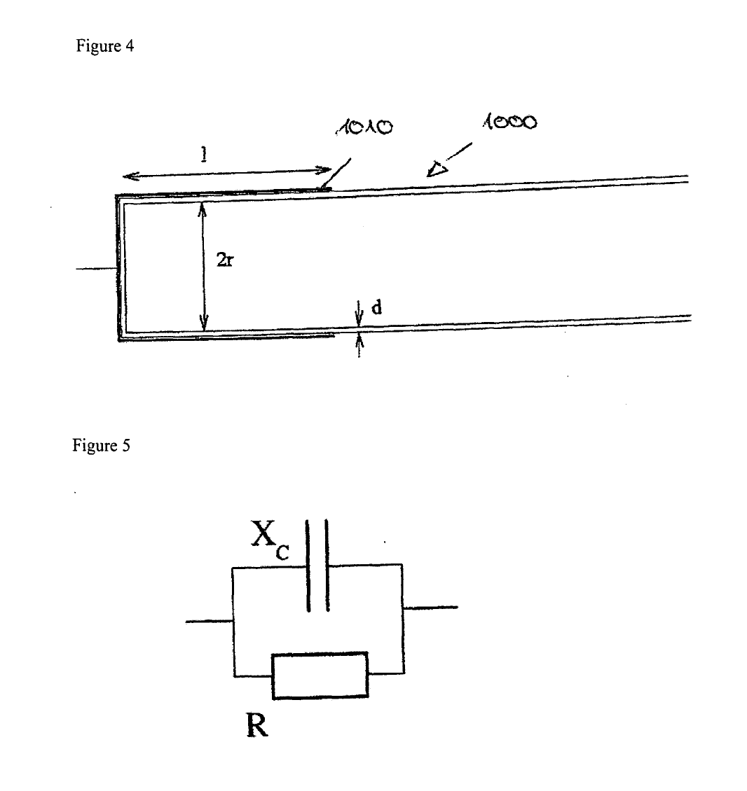

FIG. 4 shows a schematic representation of a lamp structure that was the basis for the measurements in the following Examples and

FIG. 5 shows an equivalent electric circuit (RC elements) of the representation of the lamp according to FIG. 4.

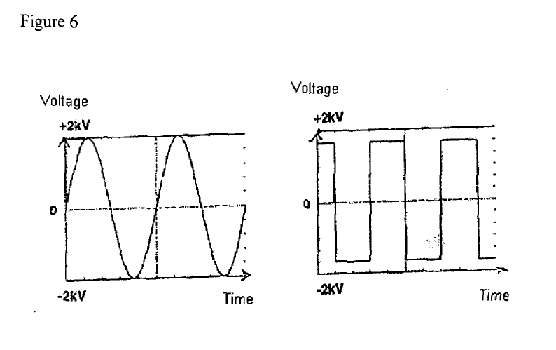

FIG. 6 shows a sinusoidal periodic voltage and a rectangular periodic voltage.

The use of backlight lamps whose lamp body contains the glass composition according to the invention or consists of it is shown as an example in FIGS. 1 to 3.

FIG. 1 shows a special use for such applications, in which individual miniaturized fluorescent tubes 110, consisting of glasses according to the invention, are employed parallel to one another and are found in a plate 130 with recesses 150, which reflect the light emitted onto the display. A reflection layer 160 is introduced above the reflecting plate 130 and this layer uniformly scatters the light emitted from the fluorescent tubes 110 in the direction of plate 130, as a type of reflector, and thus provides for a homogeneous illumination of the display. This arrangement is preferably used in larger displays, such as, e.g, in television sets.

According to the embodiment in FIG. 2, the fluorescent tubes 210 can also be introduced externally on display 202, whereby the light is then distributed uniformly over the display by means of a light-transporting plate 250, a so-called LGP (light guide plate), serving as a light guide.

In addition, it is also possible to use it for those backlight arrangements in which the light-generating unit 310 is found directly in a structured disk 315. This is shown in FIG. 3. Here, the structuring is such that channels with pregiven depth and pregiven width (d_{channel} or W_{channel}, respectively) are produced by means of parallel elevations, so-called barriers or ribs 380 with a pregiven width (W_{rib}) in the disk, and the discharge illuminating means 350 is found in these channels. Here, together with a disk, which is provided with a phosphor layer 370, the channels form several hollow radiation spaces 360. The backlight arrangement shown in FIG. 3 is an electrode-less gas discharge lamp, i.e., there are no leads, but rather only external electrodes 330a, 330b. The cover disk 410 shown in FIG. 3 can be an opaque diffusor disk or a clear transparent disk, depending on the system structure. In the electrode-less lamp system, which is shown in FIG. 3, one speaks of a so-called EEFL system (external electrode fluorescent lamp). The above-described arrangements form a large, flat backlight and are thus also denoted as a flat backlight.

FIG. 4 shows schematically a part of a lamp, in particular an EEFL glass tube, on which the measurements are conducted in the following Examples, and the measurement results were compiled in Table 9. FIG. 4 shows schematically one end of a glass tube 1000. Glass tube 1000 comprises a glass of thickness d, and the diameter of the glass tube is 2r. The electrode is designated 1010 and extends over a length I on the outside of tube 1000.

The equivalent electric circuit (RC elements) of the lamp structure according to FIG. 4 is shown in FIG. 5.

The contacts of EEFL glass tubes are formed by a cylinder, which has a radius r, typically with 0.3 mm<r<10 mm, a thickness d of the glass tube on the order of magnitude of 0.1 mm<d<0.5 mm as well as a height I of the entire contact, which lies on the order of magnitude of 0.5 cm<I<5 cm. In this case, the total capacitance can be approximated by a plate-type capacitor of a thickness d and a radius r, together with a cylindrical capacitor with a radius r and a height I. This geometry is shown in FIG. 5. The total capacitance of this geometry amounts to:

$$C = {C}_{plate} + {C}_{cylinder} = {ɛ}_{0} {ɛ}^{′} ( \frac{π {r}^{2}}{d} + \frac{2 π l}{ln ( 1 + \frac{d}{r} )} ) = {ɛ}_{0} {ɛ}^{′} G \qquad ( 1 )$$

wherein the last factor G only contains the effect of geometry,

∈₀=(μ₀c²)⁻¹=8.85418710⁻¹²AsV⁻¹m⁻¹ is the electric constant and ∈′ is the real part of the dielectric constant. The imaginary impedance of such a capacitor, which is dependent on the frequency, is given by

X_{c}=(iωC)⁻¹ (2)

wherein ω=2πv represents the angular frequency and i=√−1. Since the dielectric medium is formed by glass, the ohmic loss of the glass represents the main source for the loss of the entire discharge lamp. The total resistance of the contact region amounts to:

R=(ω∈₀∈″G)⁻¹ (3)

wherein ∈″ represents the—generally frequency-dependant—imaginary part of the dielectric function. If a voltage is applied in the contact region, the electrical resistance is disposed parallel to the capacitor, as shown in FIG. 5, which leads to the impedance Z:

Z⁻¹=χ_{c}⁻¹+R⁻¹ (4)

The total electrical loss of such an RC element, where the ohmic resistance R is much greater than the reactive impedance of the capacitor R>>I|X_{c}| results as follows:

The total current Iₜₒₜ is primarily determined by the discharge lamp. The voltage, which decreases for the contact cap, is determined by the capacitance:

U_{cont}=|X_{c}|Iₜₒₜ (5)

The part of the current that passes through the resistance is given in advance by:

$${I}_{R} = \frac{{U}_{cont}}{R} = \frac{\vert {X}_{C} \vert {I}_{tot}}{R} \qquad ( 6 )$$

The total dielectric loss of such a contact is thus:

$${P}_{loss \text{-} single} = {I}_{R} {U}_{cont} = \frac{{X}_{C}^{2} {I}_{tot}^{2}}{R} = \frac{ω {ɛ}_{0} {ɛ}^{″} G}{{( ω {ɛ}_{0} {ɛ}^{′} G )}^{2}} \qquad ( 7 )$$

Since an EEFL lamp has two such contacts, the result is multiplied by the factor of 2 and the geometric factor G is inserted. Due to the generally dynamic nature of the dielectric function, ∈′(ω) and ∈″(ω) are included.

$${P}_{loss} = 2 \frac{{ɛ}^{″} ( ω )}{{{ɛ}^{′} ( ω )}^{3}} \frac{1}{ω} \frac{1}{{ɛ}_{0}} \frac{1}{\frac{π {r}^{2}}{d} + \frac{2 π l}{ln ( 1 + \frac{d}{r} )}} {I}_{tot}^{2} \qquad ( 8 )$$

Using the relationship for the dielectric loss tangent tan δ=∈″/∈′, this leads to:

$${P}_{loss} = 2 \frac{tan δ ( ω )}{{ɛ}^{′} ( ω )} \frac{1}{ω} \frac{1}{{ɛ}_{0}} \frac{1}{\frac{π {r}^{2}}{d} + \frac{2 π l}{ln ( 1 + \frac{d}{r} )}} {I}_{tot}^{2} \qquad ( 9 )$$

In this case, the important result is obtained that the dielectric loss, independent of the geometry of the cap, is proportional to the value tan δ(ω)/∈′(ω), which is dependent on the material.

$${P}_{loss} \approx \frac{tan δ ( ω )}{{ɛ}^{′} ( ω )} . \qquad ( 10 )$$

It can be established that an exact calculation, which considers both the current through the resistance as well as also through the capacitor leads to the result:

$${P}_{loss} = 2 \frac{tan δ ( ω )}{{ɛ}^{′} ( ω )} \frac{1}{1 + {tan}^{2} δ ( ω )} \frac{1}{ω} \frac{1}{{ɛ}_{0}} \frac{1}{\frac{π {r}^{2}}{d} + \frac{2 π l}{ln ( 1 + \frac{d}{r} )}} {I}_{tot}^{2} \qquad ( 11 )$$

Since tan δ in most glasses lies on the order of magnitude of 10⁻⁴, tan²δ(ω) can be practically disregarded in the denominator in most glasses.

The present invention will be explained below on the basis of examples, which illustrate the teaching according to the invention, but do not limit it.

### EXAMPLES

Glass compositions for glass bodies of illuminating means with external electrodes as well as the tan δ[10⁻⁴]/DC quotient are indicated below. DC is the dielectric constant. The quotients of all the glass compositions according to the invention lie clearly below 5 if tan δ is given in units of 10⁻⁴, or clearly below 5×10⁻⁴ if tan δ is given in absolute units, and thus fulfill the established requirements.

TABLE 1

| Glass | | | | | | | |
|---|---|---|---|---|---|---|---|
| type | Example 1 | Example 2 | Example 3 | Example 4 | Example 5 | Example 6 | Example 7 |
| SiO₂ | 59.90 | 61.25 | 50.60 | 35.00 | 32.10 | 58.00 | 70.20 |
| B₂O₃ | 4.20 | 0.25 | 13.40 | | 2.40 | | 27.10 |
| Al₂O₃ | 14.30 | 16.50 | 11.80 | | | 1.50 | 0.70 |
| Li₂O | | | | | | | |
| Na₂O | | | | | | 4.30 | |
| K₂O | | | | 5.00 | 4.00 | 8.70 | 1.20 |
| MgO | 2.50 | | | | | | |
| CaO | 10.30 | 13.40 | | | | | |
| SrO | | | | | | | |
| BaO | 8.80 | 7.60 | 24.20 | | | | 0.80 |
| ZnO | | | | | | | |
| PbO | | | | 60.00 | 61.50 | 27.50 | |
| TiO₂ | | | | | | | |
| ZrO₂ | | 1.00 | | | | | |
| CeO₂ | | | | | | | |
| F | | | | | | | |
| Fe₂O₃ | | | | | | | |
| Sum | 100.00 | 100.00 | 100.00 | 100.00 | 100.00 | 100.00 | 100.00 |
| Quotient | 1.8 | 2.3 | 1.5 | 0.9 | 0.9 | 1.7 | 2.3 |
| tan | | | | | | | |
| δ/DC | | | | | | | |
| tan δ in | | | | | | | |
| [10⁻⁴] | | | | | | | |
| Quotient | 0.00018 | 0.00023 | 0.00015 | 0.00009 | 0.00009 | 0.00017 | 0.00023 |
| tan | | | | | | | |
| δ/DC | | | | | | | |

TABLE 2

| | | | Example | Example | Example | Example | Example |
|---|---|---|---|---|---|---|---|
| Glass type | Example 8 | Example 9 | 10 | 11 | 12 | 13 | 14 |
| SiO₂ | 59.50 | 57.00 | 60.80 | 61.60 | 63.80 | 64.50 | 5.3 |
| B₂O₃ | 5.40 | 7.90 | 6.50 | 7.80 | 9.00 | 9.00 | 15 |
| Al₂O₃ | 15.50 | 16.80 | 16.00 | 16.20 | 16.50 | 15.50 | 5 |
| Li₂O | | | | | | | |
| Na₂O | | | | | | | |
| K₂O | | | | | | | |
| MgO | 5.00 | 5.10 | 5.30 | 2.70 | 4.50 | 2.80 | 3 |
| CaO | 7.20 | 2.10 | 7.40 | 8.20 | 3.00 | 5.00 | |
| SrO | | 6.60 | | | 3.20 | | |
| BaO | 1.00 | 3.30 | 1.00 | 3.50 | | 3.20 | 71.2 |
| ZnO | 5.40 | | 2.00 | | | | |
| PbO | | | | | | | |
| TiO₂ | | 0.50 | | | | | |
| ZrO₂ | 1.00 | 0.50 | 1.00 | | | | |
| CeO₂ | | 0.20 | | | | | |
| F | | | | | | | |
| Fe₂O₃ | | | | | | | 0.5 |
| Sum | 100.00 | 100.00 | 100.00 | 100.00 | 100.00 | 100.00 | 100.00 |
| Quotient | | 2.4 | | | | | |
| tan δ/DC | | | | | | | |
| tan δ in | | | | | | | |
| [10⁻⁴] | | | | | | | |
| Quotient | | 0.00024 | | | | | |
| tan δ/DC | | | | | | | |

Additional glass compositions and embodiment examples for the invention are given below:

Additional glass compositions are indicated in the following Tables 3 to 8. Glasses according to the invention are indicated in Tables 3 to 7; a comparative example is given in Table 8. The glasses according to the present invention are preferably free of alkali.

The dielectric losses of EEFL lamps are indicated in Table 9 for the glass compositions of Examples 15, 16 and 17 from Tables 3 and 4 as well as the comparative example from Table 8.

The dielectric losses tan δ [10⁻⁴]/∈′ for temperatures of 25° C., 150° C. and 250° C. and excitation frequencies of 10 kHz, 35 kHz and 70 kHz were listed individually in Table 9. The power loss of the lamp is proportional to the quotient tan δ[10⁻⁴]/∈′. The dielectric loss of an EEFL lamp was determined assuming that a cylinder capacitor is present at both ends of the lamp, as this was explained previously in connection with FIGS. 4 and 5.

In addition, the parameters used in the measurements, such as radius of the tube of the lamp, thickness of the glass of the lamp, length of the contact, the geometric factor and the preset factor, etc., are listed in Table 9.

The numerical values for the quotients of the glass compositions according to the invention all lie below the upper limit of 5, if tan δ is indicated in units of 10⁻⁴, or below the upper limit of 5×10⁻⁴, if tan δ is given in absolute units, and thus show a clearly smaller dielectric loss than in the comparative example, according to which the quotient exceeds the critical upper limit.

The measurements accordingly confirm that it is not a deciding factor to adjust the individual values of loss angle tan δ and the dielectric constant ∈′ to be as small as possible independent of one another, but rather the two values must be set in a relationship to one another. It was surprisingly demonstrated on the basis of specific values that the quotient of the two parameters represents the critical value, by means of which the properties of the glass material are successfully adjusted, and not tan δ[10⁻⁴] alone or ∈′ alone. In this way, the total power loss of the illuminating means with external electrodes can be minimized with the present invention in a targeted manner by means of the glass properties.

TABLE 3

| | Example | Example | Example | Example | Example |
|---|---|---|---|---|---|
| Glass type | 15 | 16 | 18 | 19 | 20 |
| SiO₂ | 59.90 | 61.25 | 50.60 | 35.00 | 32.10 |
| B₂O₃ | 4.20 | 0.25 | 13.40 | | 2.40 |
| Al₂O₃ | 14.30 | 16.50 | 11.80 | | |
| Li₂O | | | | | |
| Na₂O | | | | | |
| K₂O | | | | 5.00 | 4.00 |
| MgO | 2.50 | | | | |
| CaO | 10.30 | 13.40 | | | |
| SrO | | | | | |
| BaO | 8.80 | 7.60 | 24.20 | | |
| ZnO | | | | | |
| PbO | | | | 60.00 | 61.50 |
| TiO₂ | | | | | |
| ZrO₂ | | 1.00 | | | |
| CeO₂ | | | | | |
| F | | | | | |
| Fe₂O₃ | | | | | |
| Sum | 100.00 | 100.00 | 100.00 | 100.00 | 100.00 |

TABLE 4

| Glass | Example | Example | Example | Example | Example |
|---|---|---|---|---|---|
| type | 24 | 25 | 26 | 17 | 27 |
| SiO₂ | 59.50 | 57.00 | 60.80 | 61.60 | 63.80 |
| B₂O₃ | 5.40 | 7.90 | 6.50 | 7.80 | 9.00 |
| Al₂O₃ | 15.50 | 16.80 | 16.00 | 16.20 | 16.50 |
| Li₂O | | | | | |
| Na₂O | | | | | |
| K₂O | | | | | |
| MgO | 5.00 | 5.10 | 5.30 | 2.70 | 4.50 |
| CaO | 7.20 | 2.10 | 7.40 | 8.20 | 3.00 |
| SrO | | 6.60 | | | 3.20 |
| BaO | 1.00 | 3.30 | 1.00 | 3.50 | |
| ZnO | 5.40 | | 2.00 | | |
| PbO | | | | | |
| TiO₂ | | 0.50 | | | |
| ZrO₂ | 1.00 | 0.50 | 1.00 | | |
| CeO₂ | | 0.20 | | | |
| F | | | | | |
| Fe₂O₃ | | | | | |
| Sum | 100.00 | 100.00 | 100.00 | 100.00 | 100.00 |

TABLE 5

| Glass | Example | Example | Example |
|---|---|---|---|
| type | 21 | 22 | 23 |
| SiO₂ | 58.00 | 70.20 | 68.40 |
| B₂O₃ | | 27.10 | 2.50 |
| Al₂O₃ | 1.50 | 0.70 | 2.20 |
| Li₂O | | | 0.50 |
| Na₂O | 4.30 | | 3.60 |
| K₂O | 8.70 | 1.20 | 12.40 |
| MgO | | | |
| CaO | | | |
| SrO | | | |
| BaO | | 0.80 | 5.90 |
| ZnO | | | |
| PbO | 27.50 | | |
| TiO₂ | | | |
| ZrO₂ | | | |
| CeO₂ | | | |
| F | | | 1.70 |
| Fe₂O₃ | | | 2.80 |
| Sum | 100.00 | 100.00 | 100.00 |

TABLE 6

| Glass | Example |
|---|---|
| type | 28 |
| SiO₂ | 64.50 |
| B₂O₃ | 9.00 |
| Al₂O₃ | 15.50 |
| Li₂O | |
| Na₂O | |
| K₂O | |
| MgO | 2.80 |
| CaO | 5.00 |
| SrO | |
| BaO | 3.20 |
| ZnO | |
| PbO | |
| TiO₂ | |
| ZrO₂ | |
| CeO₂ | |
| F | |
| Fe₂O₃ | |
| Sum | 100.00 |

TABLE 7

| Glass | Example | Example | Example | Example |
|---|---|---|---|---|
| type | 29 | 30 | 31 | 32 |
| SiO₂ | 56.90 | 60.35 | 50.60 | 58.60 |
| B₂O₃ | 4.20 | 0.25 | 13.40 | 7.80 |
| Al₂O₃ | 14.30 | 16.50 | 11.80 | 16.20 |
| Li₂O | | | | |
| Na₂O | | | | |
| K₂O | | | | |
| MgO | 2.50 | | | 2.70 |
| CaO | 10.30 | 13.40 | | 8.20 |
| SrO | | | | |
| BaO | 8.80 | 7.60 | 24.20 | 3.50 |
| ZnO | | | | |
| PbO | | | | |
| TiO₂ | 3.00 | | | 3.00 |
| ZrO₂ | | 1.00 | | |
| CeO₂ | | 0.50 | 0.50 | |
| SnO₂ | | 0.40 | 0.40 | |
| F | | | | |
| Fe₂O₃ | | | | |
| Sum | 100.00 | 100.00 | | 100.00 |

TABLE 8

| Glass | Comparative |
|---|---|
| type | example |
| SiO₂ | 71.9 |
| B₂O₃ | 15.7 |
| Al₂O₃ | 4 |
| Li₂O | 0.5 |
| Na₂O | 1.6 |
| K₂O | 3.7 |
| MgO | 0.4 |
| CaO | 0.7 |
| SrO | |
| BaO | 1 |
| ZnO | |
| PbO | |
| TiO₂ | 0.5 |
| ZrO₂ | |
| CeO₂ | |
| F | |
| Fe₂O₃ | |
| Sum | 100.00 |

The following Table 9.1 shows the calculated quotients tan δ/∈′ (calculated from the measured values tan δ and ∈′):

TABLE 9.1

| | 25° C. | 150° C. | 250° C. |
|---|---|---|---|
| Ex. 15/tan δ/ε′ with tan δ in [10⁻⁴] | | | |
| 10 kHz | 1.3 | 1.7 | 2.5 |
| 35 kHz | 1.3 | 1.6 | 2.2 |
| 70 kHz | 1.4 | 1.6 | 2.1 |
| Ex. 16/tan δ/ε′ with tan δ in [10⁻⁴] | | | |
| 10 kHz | 2.0 | 2.3 | 2.9 |
| 35 kHz | 2.2 | 2.4 | 2.8 |
| 70 kHz | 2.3 | 2.4 | 2.8 |
| Ex. 17/tan δ/ε′ with tan δ in [10⁻⁴] | | | |
| 10 kHz | 3.0 | 4.4 | 11.0 |
| 35 kHz | 3.2 | 4.2 | 8.0 |
| 70 kHz | 3.4 | 4.2 | 7.3 |
| Comp. Ex./tan δ/ε′ with tan δ in | | | |
| [10⁻⁴] | | | |
| 10 kHz | 6.9 | 23.7 | 91.1 |
| 35 kHz | 6.8 | 20.0 | 59.3 |
| 70 kHz | 6.6 | 18.2 | 47.7 |

Numerical example, which applies to all values in Table 9.1:

tan δ/∈′ with tan δ in [10⁻⁴]=6.9 (at 25° C.) or with tan δ as an absolute value tan δ/∈′=0.00069

It can be recognized directly from the above Table 9.1 that the glasses according to the invention at 250° C. show a quotient that is more than 20 times smaller than the comparative example.

Proceeding from this quotient, the respective power losses (Pₗₒₛₛ) were calculated for an illuminating means with the parameters indicated below:

$${P}_{loss} = 2 \frac{tan δ ( ω )}{{ɛ}^{′} ( ω )} \frac{1}{1 + {tan}^{2} δ ( ω )} \frac{1}{ω} \frac{1}{{ɛ}_{0}} \frac{1}{\frac{π {r}^{2}}{d} + \frac{2 π l}{ln ( 1 + \frac{d}{r} )}} {I}_{tot}^{2} \qquad ( 11 )$$

wherein the following applies:

| | |
|---|---|
| | (12) |
| $G = \frac{1}{\frac{{πr}^{2}}{d} + \frac{2 πl}{ln ( 1 + \frac{d}{r} )}}$ | |

| | |
|---|---|
| I in mA | 7 |
| Radius of the tube r in mm | 2 |
| Thickness of the glass d in mm | 0.3 |
| Length of the contact in mm l in mm | 18 |
| Frequency in kHz | 10 |
| Frequency in kHz | 35 |
| Frequency in kHz | 70 |
| Geometry factor G in (1/m) | 1.17 |
| Preset factor 2/(2π)*G*I*I/e0 in J206974 | 0.52 |

The exact calculation is carried out with the previously derived formula (11), wherein G can replace the above formula (12) and then the following applies:

$${P}_{loss} = 2 \frac{tan δ ( ω )}{{ɛ}^{′} ( ω )} \frac{1}{1 + {tan}^{2} δ ( ω )} \frac{1}{ω} \frac{1}{{ɛ}_{0}} {GI}_{tot}^{2}$$

$$with$$

$$π = 3.141592654$$

$${ɛ}_{0} = 8.8542 {10}^{- 12} As \text{/} ( Vm )$$

With the above given parameters, the power losses compiled in the following Table 9.2 then result for the different frequencies of 102 Hz, 352 Hz and 702 Hz.

TABLE 9.2

| | 25° C. | 150° C. | 250° C. |
|---|---|---|---|
| Ex 15: Pₗₒₛₛ in mW | | | |
| 10 kHz | 269 | 352 | 517 |
| 35 kHz | 77 | 95 | 130 |
| 70 kHz | 41 | 47 | 62 |
| Ex 16: Pₗₒₛₛ in mW | | | |
| 10 kHz | 414 | 476 | 600 |
| 35 kHz | 130 | 139 | 166 |
| 70 kHz | 68 | 71 | 83 |
| Ex 17: Pₗₒₛₛ in mW | | | |
| 10 kHz | 621 | 911 | 2277 |
| 35 kHz | 189 | 248 | 473 |
| 70 kHz | 101 | 124 | 216 |
| Comp Ex Pₗₒₛₛ in | | | |
| mW | | | |
| 10 kHz | 1418 | 4905 | 18855 |
| 35 kHz | 403 | 1183 | 3507 |
| 70 kHz | 195 | 538 | 1410 |

The frequencies used of 10 kHz, 35 kHz and 70 kHz were selected, since the lamps of interest, in particular EEFLs with external electrodes, are usually operated at frequencies of about 70 kHz. This derives also from the references already cited (Cho G. et al., J. Phys. D: Appl. Phys. Vol. 37, (2004), pp. 2863-2867 and Cho T. S. et al., Jpn. J. Appl. Phys. Vol. 41, (2002), pp. 7518-7521). That is, the lamps with the glasses according to the invention were tested under operating conditions.

In the measurements, a voltage in a range of 500 V to 6 kV, in particular 2 kV, preferably 1 kV, was applied and switched back and forth between corner values, i.e., for example, between +2 kV and −2 kV. This a.c. voltage can be, for example, sinusoidal, sawtooth-shaped, triangular, or rectangular. Other forms are also possible. As an example, a sinusoidal voltage and a rectangular voltage with corner values of +2 kV and −2 kV are shown in FIG. 6. In order to produce high voltage from the mains voltage that is present, an inverter, which represents an electronic component that provides voltages in the range of 500 V to 6 kV with a periodic time lapse, is used in the present case. This inverter is electrically connected in front of the lamp.

It can be recognized now from Table 9.1 that the glasses according to the invention show a power loss that is up to 36 times smaller than the glass of the comparative example. It is thus demonstrated that the glass compositions according to the invention actually show extremely small dielectric losses, and thus a much smaller heat absorption is present in the glass than in a comparative glass, whereupon a better efficiency of a lighting device and thus a longer service life results.

Another problem of EEFLs is so-called “pinhole burning”, which denotes a puncture at high voltages. If such a puncture occurs, then there will be a lack of tightness of the glass. This is described in detail in the above-given references of Cho et al. It has now been shown surprisingly that the glass compositions according to the invention, preferably the glass compositions given in the Tables, in particular those of embodiment examples 15, 16 and 17, which represent alkali-free glasses, do not show any pinhole burning. An undesired puncture did not occur in the investigated glasses, even for a voltage of up to 6 kV. This confirms the suitability of the glasses according to the invention for a use in the lamp region, in particular in EEFL lamps.

With the present invention, glass compositions can thus be prepared, in which the glass properties can be influenced in a targeted manner by adjusting the quotient between the loss angle tan δ[10⁻⁴] and the dielectric constant ∈′. By taking care that the upper limit is 5 or 5×10⁻⁴ for this quotient according to the invention, it is possible for the first time, with the teaching of the invention, to reduce to a minimum the total power loss of glass compositions and thus to obtain an optimal efficiency in illuminating means with external electrodes.

1. An illuminating means with external electrodes, comprising:
a glass composition, wherein the quotient of the loss angle (tan δ[10⁻⁴]) and the dielectric constant (∈′) amounts to tan δ[10⁻⁴]/∈′ less than 5.

2. The illuminating means according to claim 1, wherein the quotient tan δ[10⁻⁴]/∈′ amounts to less than about 4.

3. The illuminating means according to claim 1, wherein the quotient tan δ[10⁻⁴]/∈′ amounts to less than about 3.

4. The illuminating means according to claim 1, comprising a power loss Pₗₒₛₛ as given by:
$${P}_{loss} \approx 2 \cdot \frac{1}{ω \cdot {ɛ}_{0}} \cdot \frac{tan δ ( {10}^{- 4} )}{{ɛ}^{′}} \frac{d}{A} \cdot {I}^{2}$$
wherein the following apply:
ω: angular frequency
tan δ[10⁻⁴]: loss angle in [10⁻⁴]
∈′: dielectric constant
d: thickness of the capacitor (here: thickness of the glass)
A: electrode surface and
I: current intensity
∈₀: electric constant=8.8542 10⁻¹² As/(Vm).

5. The illuminating means according to claim 1, further comprising at least one highly polarizable element in oxide form is incorporated into the glass composition.

6. The illuminating means according to claim 5, wherein the at least one highly polarizable element in oxide form is selected from the group consisting of the oxides of Ba, Cs, Hf, Ta, W, Re, Os, Ir, Pt, Pb, Bi, La, Ce, Pr, Nd, Sm, Eu, Gd, Tb, Dy, Ho, Er, Tm, Yb, Lu, and any combinations thereof.

7. The illuminating means according to claim 5, wherein the at least one highly polarizable element in oxide form is present in an amount of at least 8 wt. %.

8. The illuminating means according to claim 5, wherein the at least one highly polarizable element in oxide form is present in an amount of at least 20 wt. %.

9. The illuminating means according to claim 1, wherein the glass composition comprises:

| | | |
|---|---|---|
| SiO₂ | 55-85 | wt. % |
| B₂O₃ | >0-35 | wt. % |
| Al₂O₃ | 0-25 | wt. %, [[,]] |
| Li₂O | <1.0 | wt. % |
| Na₂O | <3.0 | wt. % |
| K₂O | <5.0 | wt. %, wherein the |
| Σ Li₂O + Na₂O + K₂O | <5.0 | wt. %, and |
| amounts to | | |
| MgO | 0-8 | wt. % |
| CaO | 0-20 | wt. % |
| SrO | 0-20 | wt. % |
| BaO | 0-80 | wt. %, |
| TiO₂ | 0-10 | wt. %, [[,]] |
| ZrO₂ | 0-3 | wt. % |
| CeO₂ | 0-10 | wt. % |
| Fe₂O₃ | 0-3 | wt. %, |
| WO₃ | 0-3 | wt. %, |
| Bi₂O₃ | 0-80 | wt. %, |
| MoO₃ | 0-3 | wt. %, |
| SnO₂ | 0-2 | wt. %, |
| ZnO | 0-15 | wt. %, |
| PbO | 0-70 | wt. %, wherein |

the Σ Al₂O₃ + B₂O₃ + BaO + PbO + Bi₂O₃ amounts to 10-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

10. The illuminating means according to claim 1, wherein the glass composition comprises:

| | | |
|---|---|---|
| SiO₂ | 55-85 | wt. %, |
| B₂O₃ | >0-35 | wt. %, |
| A1₂O₃ | 0-20 | wt. %, |
| Li₂O | <0.5 | wt. %, |
| Na₂O | <0.5 | wt. %, |
| K₂O | <0.5 | wt. %, wherein the |
| Σ Li₂O + Na₂O + K₂O amounts to | <1.0 | wt. %, and |
| MgO | 0-8 | wt. %, |
| CaO | 0-20 | wt. %, |
| SrO | 0-20 | wt. %, |
| BaO | 15-60 | wt. %, wherein the |
| Σ MgO + CaO + SrO + BaO amounts to | 15-70 | wt. %, and |
| TiO₂ | 0-10 | wt. %, |
| ZrO₂ | 0-3 | wt. %, |
| CeO₂ | 0-10 | wt. %, |
| Fe₂O₃ | 0-1 | wt. %, |
| WO₃ | 0-3 | wt. %, |
| Bi₂O₃ | 0-80 | wt. %, |
| MoO₃ | 0-3 | wt. %, |
| SnO₂ | 0-2 | wt. %, |
| ZnO | 0-10 | wt. %, |
| PbO | 0-70 | wt. %, wherein |

the Σ Al₂O₃ + B₂O₃ + BaO + PbO + Bi₂O₃ amounts to 10-80 wt. %, as well as refining agents in the usual concentrations.

11. The illuminating means according to claim 1, wherein the glass composition comprises:

| | | |
|---|---|---|
| SiO₂ | 35-65 | wt. %, |
| B₂O₃ | 0-15 | wt. %, |
| Al₂O₃ | 0-20 | wt. %, |
| Li₂O | 0-0.5 | wt. % |
| Na₂O | 0-0.5 | wt. %, |
| K₂O | 0-0.5 | wt. %, wherein the |
| Σ Li₂O + Na₂O + K₂O | 0-1 | wt. %, and |
| amounts to | | |
| MgO | 0-6 | wt. %, |
| CaO | 0-15 | wt. %, |
| SrO | 0-8 | wt. %, |
| BaO | 1-20 | wt. %, |
| TiO₂ | 0-10 | wt. %, |
| ZrO₂ | 0-1 | wt. %, |
| CeO₂ | 0-0.5 | wt. %, |
| Fe₂O₃ | 0-0.5 | wt. %, |
| WO₃ | 0-2 | wt. %, |
| Bi₂O₃ | 0-20 | wt. %, |
| MoO₃ | 0-5 | wt. %, |
| SnO₂ | 0-2 | wt. %, |
| ZnO | 0-5 | wt. %, |
| PbO | 0-70 | wt. %, wherein |

the Σ Al₂O₃ + B₂O₃ + BaO + PbO + Bi₂O₃ amounts to 8-65 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

12. The illuminating means according to claim 1, wherein the glass composition comprises:

| | | |
|---|---|---|
| SiO₂ | 50-65 | wt. %, |
| B₂O₃ | 0-15 | wt. %, |
| A1₂O₃ | 1-17 | wt. %, |
| Li₂O | 0-0.5 | wt. %, |
| Na₂O | 0-0.5 | wt. %, |
| K₂O | 0-0.5 | wt. %, wherein the |
| Σ Li₂O + Na₂O + K₂O | 0-1 | wt. %, and |
| amounts to | | |
| MgO | 0-5 | wt. %, |
| CaO | 0-15 | wt. %, |
| SrO | 0-5 | wt. %, |
| BaO | 20-60 | wt. %, |
| TiO₂ | 0-1 | wt. %, |
| ZrO₂ | 0-1 | wt. %, |
| CeO₂ | 0-0.5 | wt. %, |
| Fe₂O₃ | 0-0.5 | wt. %, |
| WO₃ | 0-2 | wt. %, |
| Bi₂O₃ | 0-40 | wt. %, |
| MoO₃ | 0-5 | wt. %, |
| ZnO | 0-3 | wt. %, |
| SnO₂ | 0-2 | wt. %, |
| PbO | 0-30 | wt. %, wherein |

the Σ Al₂O₃ + B₂O₃ + BaO + PbO + Bi₂O₃ amounts to 10-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

13. The illuminating means according to claim 1, wherein the content of alkali in the glass composition amounts to <1.0 wt. %.

14. The illuminating means according to claim 1, wherein the glass composition is free of alkali.

15. The illuminating means according to claim 9, wherein the content of BaO in the glass composition is greater than 15 wt. %.

16. The illuminating means according to claim 9, wherein the content of BaO in the glass composition is greater than 20 wt. %.

17. The illuminating means according to claim 1, wherein the content of BaO in the glass composition lies between 20 and 60 wt. %.

18. The illuminating means according to claim 9, wherein if the content of PbO in the glass composition is more than 50 wt. %, then the alkali content amounts to more than 3 wt. %.

19. The illuminating means according to if the glass composition does not contain PbO, the content of alkali amounts to <1.0 wt. %.

20. The illuminating means according to claim 9, wherein if the glass composition contains PbO, the content of BaO is <10 wt. %.

21. The illuminating means according to claim 1, wherein the glass composition comprises SiO₂ with or without doping oxides.

22. The illuminating means according to claim 21, wherein the glass composition comprises:

| | |
|---|---|
| SiO₂ | 90-100 wt. %, |
| TiO₂ | 0-10 wt. %, |
| CeO₂ | 0-5 wt. %, |

wherein the upper limit of the SiO₂ content is given by: 100 wt. % [[-(]]minus [[)]] all lower limits of the oxides present, except for SiO₂.

23. The illuminating means according to claim 21, wherein the glass consists only of SiO₂.

24. The illuminating means according to claim 1, wherein the illuminating means comprises a discharge lamp.

25. The illuminating means according to claim 24, wherein the discharge lamp comprises a discharge space and the discharge space is filled with discharge substances.

26. The illuminating means according to claim 1, wherein the illuminating means comprises a fluorescent lamp, which is an illumination for a device selected from the group consisting of LCD displays, computer monitors, telephone displays, and displays.

27-28. (canceled)

29. The illuminating means according to claim 1, wherein the illuminating means is an illumination for a device selected from the group consisting of LCD displays, computer monitors, TFT devices, telephone displays, scanners, advertising signs, medical instruments and devices of air and space travel, navigation devices, and personal digital assistants.

30. An external electrode fluorescent lamp, comprising: a glass body having a glass composition comprising

| | | |
|---|---|---|
| SiO₂ | 55-85 | wt. %, |
| B₂O₃ | >0-35 | wt. %, |
| Al₂O₃ | 0-25 | wt. %, |
| Li₂O | <1.0 | wt. %, |
| Na₂O | <3.0 | wt. %, |
| K₂O | <5.0 | wt. %, |
| MgO | 0-8 | wt. %, |
| CaO | 0-20 | wt. %, |
| SrO | 0-20 | wt. %, |
| BaO | 0-80 | wt. %, |
| TiO₂ | 0-10 | wt. %, |
| ZrO₂ | 0-3 | wt. %, |
| CeO₂ | 0-10 | wt. %, |
| Fe₂O₃ | 0-3 | wt. %, |
| WO₃ | 0-3 | wt. %, |
| Bi₂O₃ | 0-80 | wt. %, |
| MoO₃ | 0-3 | wt. %, |
| SnO₂ | 0-2 | wt. %, |
| ZnO | 0-15 | wt. %, |
| PbO | 0-70 | wt. %, and |

an oxide form of an element selected from the group consisting of Hf, Ta, W, Re, Os, Ir, Pt, La, Pr, Nd, Sm, Eu, Gd, Tb, Dy, Ho, Er, Tm, Yb, Lu, and any combinations thereof, the oxide form being present in an amount of 0-80 wt. %, wherein the Σ Al₂O₃ + B₂O₃ + BaO + PbO + Bi₂O₃ amounts to 10-80 wt. % and the Σ Li₂O + Na₂O + K₂O amounts to <5.0 wt. %.

31. The external electrode fluorescent lamp according to claim 30, wherein the glass composition comprises Al₂O₃ 0-20 wt. %.

32. The external electrode fluorescent lamp according to claim 30, wherein the glass composition comprises BaO 0-60 wt. %.

33. The external electrode fluorescent lamp according to claim 30, wherein the glass composition comprises TiO₂>0.5-10 wt. %.

34. The external electrode fluorescent lamp according to claim 30, wherein the glass composition comprises Fe₂O₃ 0-1 wt. %

35. The external electrode fluorescent lamp according to claim 30, wherein the glass composition comprises ZnO 0-5 wt. %.

36. The external electrode fluorescent lamp according to claim 30, wherein the glass composition comprises a dielectric constant in the range of 3.5 to 4.5.

37. The external electrode fluorescent lamp according to claim 30, wherein the glass composition comprises a dielectric constant >8.

38. A method of providing a glass composition for a glass body of an illuminating device with external electrodes, comprising:
selecting the glass composition so that a quotient of a loss angle and a dielectric constant that amounts to less than 5×10⁻⁴.

39. The method according to claim 38, wherein the quotient amounts to less than about 4×10⁴.

40. The method according to claim 38, wherein the quotient amounts to less than about 3×10⁴.

41. The method according to claim 38, further comprising selecting the glass composition so that the dielectric constant is in a range of 3.5×10⁴ to 4.5×10⁴.

42. The method according to claim 38, further comprising selecting the glass composition so that the dielectric constant is less than 8.

43. The method according to claim 38, further comprising incorporating at least one highly polarizable element in oxide form into the glass composition.

44. The method according to claim 38, further comprising selecting the glass composition so that a content of alkali amounts to less than 1.0 wt. %.

45. The method according to claim 38, further comprising selecting the glass composition so that the glass composition is free of alkali.
